(19) United States
(12) Patent Application Publication
(10) Pub. No.: US 2007/0147320 A1
(43) Pub. Date: Jun. 28, 2007

(54) Access router selection method

(75) Inventors: Nima Sattari, Surrey (GB); Nima Nafisi, Poitiers (FR); Paul Anthony Pangalos, London (GB); Abdol Hamid Aghvami, London (GB)

Correspondence Address: KELLEY DRYE & WARREN LLP, 400 ATLANTIC STREET, 13TH FLOOR, STAMFORD, CT, 06901, US

(73) Assignee: King's College London, London (GB)

(21) Appl. No.: 11/524,610

(22) Filed: Sep. 21, 2006

(30) Foreign Application Priority Data
Sep. 21, 2005 (GB) 0519257.0

(51) Int. Cl. H04Q 7/24

(52) U.S. Cl. 370/338

(57) ABSTRACT

In a heterogeneous network environment a method of selecting an access router (20) among a number of available access routers (20, 22, 24) for a group of mobile network nodes (14) attached to a mobile router (12), each access router (20, 22, 24) providing access to packet-switched resources in a respective network domain (26, 28, 30) and each mobile network node (14) having a desired QoS level at the network layer, which method comprises the steps of:
(a) determining a group QoS level acceptable to substantially all mobile network nodes (14) in said group;
(b) using said group QoS level to query at least one of said number of respective network domains (26, 28, 30) to determine whether or not it can meet said group QoS level; and
(c) using a response from said at least one network domain (26, 28, 30) to decide whether or not to perform a network layer handover of said group of mobile network nodes (14) to one of said number of available access routers (20, 22, 24).

### CROSS-REFERENCE TO RELATED APPLICATIONS

This application claims priority from application number GB 0519257.0, filed Sep. 21, 2005. The disclosure of each such application is hereby incorporated by reference in its entirety where appropriate for teachings of additional or alternative details, features, and/or technical background, and priority is asserted from each.

### FIELD OF THE INVENTION

The present invention relates to a method of selecting an access router and to a computer program for performing the method.

### BACKGROUND OF THE INVENTION

Network mobility support is concerned with managing the mobility of an entire network, viewed as a single unit, which changes its point of attachment to a fixed network infrastructure and thus its reachability in the network topology, most frequently the Internet. The mobile part of the network is referred to as a “mobile network”, that can be installed in a train for example, and which includes one or more “mobile routers” (MRs) which act as gateways to the mobile network and connect it to the global Internet, often via intermediate network domains i.e. access networks. Nodes behind the MR(s) can be classified as “Local Fixed Nodes” (LFNs) such as wired Internet access point on the train, Local Mobile Nodes (LMNs) such as mobile PDAs carried by personnel working on the train, and Visiting Mobile Nodes (VMNs) such as notebook computers and mobile telephones carried by passengers on the train. In most cases, the internal structure of the mobile network will in effect be relatively stable (no dynamic change of the topology), subject to joining and leaving of VMNs and LMNs. The MR provides wireless access for the network nodes via access routers that are part of the fixed network infrastructure. Access routers include satellites, UMTS Node Bs, GSM base stations, DVB transmitters and wireless access points.

The mobility of mobile networks does not cause the network nodes to change their own physical point of attachment, although they happen to change their topological location with respect to the global Internet. If network mobility is not explicitly supported by some mechanisms, the mobility of the MR results in mobile nodes losing Internet access and breaking ongoing connections with correspondent nodes (hereinafter CNs) in the global Internet. In addition, the communication path between the network nodes and the CNs becomes sub-optimal.

The current solution to provide network mobility is promoted by the NEtworks in MOtion (NEMO) working group of the Internet Engineering Task Force (see www.ietf.org/html.charters/nemo-charter.html). “NEMO Basic Support” (see <draft-ietf-nemo-basic-support-03.txt> at the same website) aims to provide connection continuity for nodes in the mobile network, whilst optimization mechanisms will be provided in “NEMO Extended Support” of which there is an Internet Draft by Perera et al.

NEMO Basic Support provides connection (or session) continuity (e.g. continuity for TCP connections) by creating a “bi-directional tunnel” (NEMOBT) between the MR and its home network. This bi-directional tunnel is formed by encapsulating IP packets to and from the network nodes in IP packets addressed between the MR and a Home Agent on the MR's home network. In this way traffic flows are routed via the MR and its Home Agent and the mobility of the mobile network is transparent to all network nodes attached thereto. It is proposed that the MR only changes access router when signal quality degrades, for example when it moves out of signal range of an access point.

The increasing variety of access networks covering the same physical area means that the MR may have a number of access routers to choose from at any one time, depending on its location and assuming that it has multiple interfaces or has a single reconfigurable interface. For example there may be a DVB network, a UMTS network and a WLAN all covering the same physical area and therefore all able to serve the MR and its attached network nodes. Such an environment is herein referred to as a heterogeneous network environment. As all of these networks offer packet-switched resources and a gateway to the Internet the MR may select any one of them.

The VMNs attached to the MR may specify some Quality of Service (QoS) at the network layer that they wish to receive. Such a guarantee of QoS may be important if the user has a real-time application such as Voice over IP, or simply if the user has paid for a premium service and expects higher bandwidth for example. QoS may be interpreted broadly as any measure of the service provided by the network layer such as bandwidth, delay or packet loss; the user may seek a guarantee quantified in terms of any one or a combination of measures. Although primarily a research topic at present, it is expected that QoS enabled domains will find widespread acceptance in the marketplace over the coming years. Diffserv (see e.g. RFC 2475) is one of the most promising protocols for effecting the upgrade from best-effort to QoS-oriented service.

Presently if a mobile network node operating Mobile IP wishes to guarantee some QoS it must negotiate individually with the network domain to which it may attach. US 2004/0240414 (Changpen et al.) discloses a method for carrying our QoS-oriented handoff between first and second IP-based communication paths in a single access network. Should a mobile node need to handover from a first path to a second path it sends a Binding Update (BU) message containing the QoS requirements along the second path. The BU message is sent progressively between routers on the path and each router checks whether or not it can meet the QoS requirement. The BU message is only forwarded to the next router if the QoS requirement can be met. If not a negative Binding Acknowledgement (BA) is sent back to the mobile node. Potentially it is necessary for each mobile node to investigate a large number of paths before finding an end-to-end path across the domain that meets its QoS requirements.

The requirement of QoS investigation of each potential path is not compatible with the aims of NEMO. In particular, a very large signalling overhead would be generated on the wireless link if the method of Changpen et al. were employed within a NEMO network since all of the attached network nodes would undergo network layer handover substantially simultaneously. Furthermore the complexity and delay would be greatly increased if more than one type of access network became involved. For example if the mobile router had access to three kinds of access network it would be necessary for each mobile node attached to the mobile router to investigate a large number of possible communication paths on one of the access networks, and then repeat the process on the remaining two networks before it is able to decide which is the best one to attach to from a QoS point of view.

Still further, each VMN may have its QoS requirements stored in a user profile on its home network. In order to select an access router the mobile router would need to consult the or each home networks of the VMNs attached to it in order to discover the required QoS. If this selection process is to be performed by the mobile router, such signalling is an unwanted overhead on the wireless link.

Accordingly it is apparent that there is a need for a QoS-aware access router selection method that mitigates the aforementioned disadvantages, and in particular that can facilitate a QoS-oriented selection of an access router in a heterogeneous network environment without requiring individual network nodes to communicate with the available access networks.

### SUMMARY OF THE PRESENT INVENTION

According to the present invention there is provided in a heterogeneous network environment a method of selecting an access router among a number of available access routers for a group of mobile network nodes attached to a mobile router, each access router providing access to packet-switched resources in a respective network domain and each mobile network node having a desired QoS level at the network layer, which method comprises the steps of:

(a) determining a group QoS level acceptable to substantially all mobile network nodes in said group;

(b) using said group QoS level to query at least one of said number of respective network domains to determine whether or not it can meet said group QoS level; and

(c) using a response from said at least one network domain to decide whether or not to perform a network layer handover of said group of mobile network nodes to one of said number of available access routers. (query may direct or indirect)

Advantageously, steps (a) to (c) are performed in response to a request for service sent by one of said mobile network nodes. In this way the group of mobile nodes may comprise only those network nodes that have requested a service. Furthermore performing the method in response to a request for service enables the group QoS level to be substantially continuously adjusted and for that QoS level to be handled by the most appropriate access router.

Preferably, steps (a) to (c) are performed in response to the need for a network layer handover indicated by a degradation of wireless signal quality.

Advantageously, wherein step (b) comprises the step of composing a Service Request Message having fields for carrying data representing said group QoS level and an identity of each of said number of available access routers.

Preferably, said Service Request Message comprises a field for carrying data representing an identity of a mobile network node. In some embodiments this provides a reduced data overhead as the QoS requirements of the mobile netork node do not need to be sent in the Service Request Message.

Advantageously, step (a) comprises the step of evaluating said group QoS level by selecting a highest QoS from among the QoS level desired by each mobile network node. This may be done by examining the performance attributes required by the group of network nodes and selecting the highest QoS level(s) required by those nodes as expressed, for example, by a different performance metrics.

Preferably, said QoS level is a performance attribute of packet routing at the network layer.

Advantageously, step (b) comprises the steps of composing at least one Resource Allocation Request (RAR) message having a field for said group QoS level, transmitting said at least one RAR message to a respective network domain and awaiting a response therefrom. In one embodiment the RAR message is sent to a Bandwidth Broker in each respective network domain.

Preferably, if the or each respective network domain indicates that it cannot meet the requested group QoS level, said group QoS is re-evaluated by selecting a lower QoS level from among the QoS level desired by each mobile network node, and a further RAR is composed and transmitted to said respective network domain. This process may be repeated until at least one of the network domains indicates that it can meet the QoS desired.

Advantageously, step (c) comprises the step of awaiting at least one Resoure Allocation Answer (RAA) message from said respective network domain and, if a positive RAA message is received indicating that network domain can meet said group QoS level, handing said group of mobile network nodes over to the available access router in that network domain.

Preferably, wherein if more than one positive RAA message is received, the method further comprises the step of selecting an available access router according to a home network condition of said mobile router.

Advantageously, in response to a query sent in step (b) said at least one respective network domain determines whether or not a path exists thereacross that meets said group QoS level.

Preferably, said at least one network domain uses a QoS link state routing alorithm whereby each router of the domain has knowledge of the QoS capability of every other link within said domain, whereby said path being determined by examination of a routing table within one router in the domain.

Advantageously, the method further comprises the step of confirming selection of one of said respective network domains, and in response to said confirmation said selected network domain reserves resources to meet said group QoS level.

Preferably, the method further comprises the steps of applying a Mobility Aware Code Point (MACP) to packet data entering said selected network domain that originates from said group of mobile network nodes, which MACP causes said packet data to be prioritised relative to other packet data at routers within said selected network domain.

Advantageously, the method further comprises the step of applying within said selected network domain a lower marking probability to packet data flows comprising said MACP, whereby those packet data flows from said mobile network nodes are protected relative to other packet data flows in said selected network domain. The marking may be by dropping a packet or setting the Explicit Congestion Notification (ECN) bit for example.

Preferably, the method further comprises the step of applying said MACP for at least the duration of said network layer handover.

Advantageously, said query in step (b) is transmitted to a handover entity intermediate said group of mobile network nodes and said respective network domains. The handover entity may reside on the mobile router or at remote location.

Preferably, said handover entity performs steps (a) and (b).

Advantageously, said group QoS level is acceptable or substantiallly acceptable to all of said group of mobile network nodes. To be substantially acceptable the group QoS may be within some predetermined limit from the desired group QoS level.

Preferably, said mobile router and said group of mobile network nodes comprise a mobile network.

Advantageously, said mobile network operates using NEMO, NEMO-like or NEMO-derived protocol.

Preferably, said method is performed by network nodes in different network domains, the arrangement being such that:

(a) the method steps of any of claims 2 to 5 are performed by mobile routers moving in the hetereogeneous network environment;

(b) the method steps of any of claims 6 to 11 are performed by a handover entity; and

(c) the method steps of any of claims 12 to 17 are performed by a bandwidth broker in each of said respective network domains to which said mobile routers have access.

In one embodiment said handover entity operates on a network node remote from said mobile router, providing a single network node to which queries from said mobile routers can be directed.

In another embodiment said handover entity operates on each mobile router.

According to another aspect of the present invention there is provided a computer program comprising computer executable instructions for causing one or more network node to perform the method steps set out above.

According to another aspect of the present invention there is provided a computer program product storing computer executable instructions as aforesaid.

Advantageously, the computer program product is embodied on a record medium, in a computer memory, in a read-only memory or on an electrical carrier signal.

### BRIEF DESCRIPTION OF THE FIGURES

For a better understanding of how the invention may be put into practice, preferred embodiments of the invention applied in a heterogeneous network environment comprising a WLAN network, a DVB network and a UMTS network will be described, by way of example only, with reference to the accompanying drawings, in which:

FIG. 1 is a schematic block diagram of a heterogeneous network environment with a NEMO network moving therethrough;

FIG. 2 is a signalling diagram of a first embodiment of a method in accordance with the present invention;

FIG. 3 is a block diagram of a mobile router in accordance with the present invention;

FIG. 4 is a flowchart of steps of a method in accordance with the present invention performed by the mobile router of FIG. 3;

FIG. 5 is a flowchart of the steps of a method in accordance with the present invention performed by a handover entity;

FIG. 6 is a block diagram of a bandwidth broker in accordance with the present invention;

FIG. 7 is a flowchart of the steps of a method in accordance with the present invention performed by the bandwidth broker of FIG. 6;

FIG. 8 is a graph of packet queue length versus dropping probability in accordance with the present invention; and

FIG. 9 is a signalling diagram of a second embodiment of a method in accordance with the present invention.

### DETAILED DESCRIPTION OF THE PREFERRED EMBODIMENTS

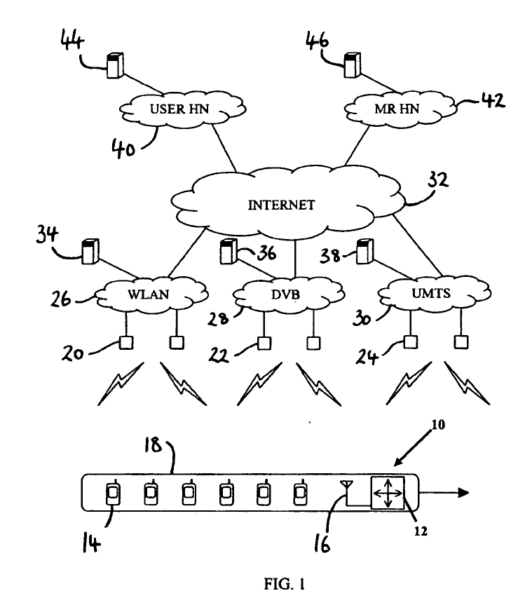

Referring to FIG. 1 a mobile network generally identified by reference numeral 10 comprises a mobile router (MR) 12, serving a Visiting Mobile Node (VMN) 14 (that is multi-mode) via an access point (AP) 16. The AP 16 is a wireless access point although it may be a wired access point. The mobile network 10 is part of a train 18 that moves relative to a number of physically fixed access routers 20, 22 and 24 that are not part of the train 18: access router 20 (also called an access point) operates under a wireless local area network (WLAN) communication protocol such as IEEE802.11 and is part of a WLAN network 26; access router 22 (also called a transmitter) is a Digital Video Broadcast (DVB) access router operating under a DVB transmission protocol and is part of a DVB network 28; and access router 24 (also called a Node B) is a Universal Mobile Telecommunications System (UMTS) access router operating under a UMTS communication protocol, or other IMT-2000 communication protocol and is part of a UMTS network 30. The network clouds in FIG. 1 represent different network domains, each of which is Diffserv-capable (see e.g. RFC 2475) and each operates a QoS routing algorithm described in RFC 2676 modified for Diffserv as described below. RFC 2676 describes an extension to the Open Shortest Path First (OSPF) routing algorithm; the extension enables distribution of QoS information amongst all routers in each network domain. Each of the access routers 20, 22 and 24 provides wireless access for the MR 12 and the VMN 14 to a fixed packet-switched network, such as the Internet 32, so that the VMN 14 can send and receive packet data from the train 18, both whilst moving and stationary. The MR 12 has an ingress interface for receiving IP packets from and transmitting IP packets to network nodes in the mobile network 10, and an egress interface for receiving IP packets from and transmitting IP packets to the fixed packet-switched network.

Access to the Internet 32 from the WLAN 26, DVB network 28 and UMTS network 30 is provided by a respective gateway in each network (not shown). Furthermore each network has a respective Bandwidth Broker (BB) 34, 36, 38. Each BB 34, 36, 38 is a software application that is stored and executed on a network node within each domain. Further details of the architecture and function of Bandwidth Brokers can be found in “A Discussion of Bandwidth Broker Requirements for Internet Qbone Deployment”, Neilson, R. et al., August 1999 to which reference is specifically made, hereinafter referred to as Neilson. For example the BB 34 may function on the gateway router (not shown) in the WLAN network 26; the BB 36 may function on the DVB gateway (not shown) in the DVB network 28; and the BB 38 may function on the GGSN (not shown) in the UMTS network 30. The purpose of each BB 34, 36, 38 is to manage the QoS resources within a domain based on the Service Level Specifications (SLSs)that have been agreed in that domain (intra-domain communication), and to manage communication with other BBs in different domains (inter-domain communication). In this case, the BB 34 is responsible for the QoS resources in the WLAN network 26; the BB 36 is responsible for the QoS resources in the DVB network 28; and the BB 38 is responsible for the QoS resources in the UMTS network 30. Given a specific QoS request by a user or other BB, a BB determines whether or not the requested QoS can be met by network nodes (usually routers) within the domain from one gateway in the domain to another. Each BB has access to the routing table of the network node on which it resides; accordingly by means of the protocol discussed in RFC 2676 it is aware of the QoS level (e.g. bandwidth) available over all links in its domain.

As explained above, one of the aims of the NEMO Basic Support is to ensure that the motion of the train 18 is transparent to any network nodes (LFN, LMN and/or VMN) behind the MR 12. Motion of the train past the access routers 20, 22, 24 necessitates network layer handover of service from one access router to another. Since the MR 12 connects an entire network to remote packet networks, each change in point of attachment (i.e. change in access router) to the remote packet networks causes the reachability of the entire mobile network 10 to change. Without appropriate mechanisms, connections (e.g. TCP) established between nodes in the mobile network 10 and nodes in the remote packet networks cannot be maintained across each handover. Connection continuity is primarily achieved in NEMO Basic Support through establishment of a bidirectional tunnel (herein NEMOBT) between the MR 12 and a Home Agent (HA_MR) of the MR 12. Aspects of the operation of the NEMOBT relevant to the present invention will be briefly described below. Further details can be found in “Basic Network Mobility Support”, Wakikawa, R et al. (draft-wakikawa-nemo-basic-00.txt) and “Network Mobility (NEMO) Basic Support Protocol” Devarapalli, V. et al., both presently available at www.ietf.org/html.charters/nemo-charter.html.

The Mobile Internet Protocol (Mobile IP) was designed specifically to handle the routing of IP data packets to and/or from mobile nodes (i.e. mobile terminals that frequently change their point of attachment to the Internet). Moreover, Mobile IP was designed to handle the routing of IP data packets to and/or from mobile nodes without significantly interrupting on-going communications and without requiring mobile nodes to restart applications. Presently there are two versions of Mobile IP that have been proposed by the Internet Engineering Taskforce (IETF): Mobile IPv4 and Mobile IPv6. One of the common features between the two protocols is that an interface on each mobile network node has (1) a “home address” i.e. a permanent IP address for an interface associated with the mobile node's point of attachment to the Internet at its home network, and (2) a “care-of address” i.e. a temporary IP address that is assigned to the interface when the mobile node attaches to a foreign network. In this case the VMN 14 has a home network 40 (“USER HN”) and the MR 12 has a home network 42 (“MR HN”). Whenever a mobile node (e.g. the VMN 14) attaches to a foreign network it sends a “binding update” to a special agent called a “Home Agent” 44 (herein HA_VMN) on the home network 40. The HA_VMN 44 maintains a binding database that maps the VMN's home address to the latest care-of address. IP data packets arriving at the HA_VMN 44 are encapsulated in another IP header and sent to the care-of address where the VMN decapsulates the packet to reveal the original IP packet from the CN addressed to the VMN's home address. A similar process happens for packets from the mobile node addressed to the CN. This process is known as “bidirectional tunnelling” (herein MIPBT) between the mobile node and Home Agent. Mobile IPv6 adds some extra functionality over Mobile IPv4. In particular, each VMN sends the binding updates to its HA_VMN and each CN. In this way, each CN can send IP packets directly to the care-of address of the VMN and vice versa, whereby the use of the MIPBT is mitigated. This is known as Route Optimisation.

If the MR 12 is at its home network 42 the prefix advertised over the ingress interface matches the prefix of the egress interface of the MR 12. Accordingly, when a VMN 14 moves into the area served by the MR 12 and AP 16 the newly configured care-of address is topologically correct i.e. IP packets addressed to the care-of address configured using the prefix of the ingress interface will be routed correctly and reach the egress interface of the MR 12 where they are routed to the VMN 14. However, when the mobile network 10 moves away from its home network (for example the station where the train 18 commences its journey), the care-of address configured by the VMNs from the ingress interface of the MR 12 is no longer topologically correct and IP packets sent by CNs will not reach their destination.

The NEMO standard deals with this problem by establishment of a NEMO Bidirectional Tunnel (NEMOBT) between the MR 12 and a Home Agent (not shown; herein HA_MR) of the MR 12, and specifies that all incoming and outgoing IP traffic should be routed via this NEMOBT. It is to be noted that the NEMOBT separate and distinct from any MIPBT used under Mobile IP.

On top of this functionality, each network node 14 may demand different QoS, and possibly even a different QoS per service (i.e. a different QoS for FTP, voice, web-browsing, etc.). As mentioned above, existing solutions for provision of QoS to mobile network nodes are not readily applied in group mobility scenarios such as NEMO. In the existing solutions, network nodes make QoS requests individually to a network domain e.g. as described in US 2004/0240414. In a NEMO scenario the associated signalling overhead would be prohibitive, bearing in mind the limited bandwidth available on the wireless link between access routers 20, 22, 24 and the MR 12. The applicant has also realised that the heterogeneous network environment provides an opportunity for the MR 12 to choose its point of attachment to the Internet 32 via access routers 20, 22, 24, based on the QoS requirements of the network nodes it serves.

Accordingly the mobile router's home network 42 also comprises a Handover Entity 46 (hereinafter HE 46). The applicant has already proposed the concept of the HE in the paper “Seamless Handovers between WLAN and UMTS Networks”, Sattari, N. et al., VTC2004, Milan, Italy, May 2004. New functionality is provided in the HE by the present invention as described in greater detail below; it will be appreciated that the new functionality may be performed independently of the functionality described in the aforementioned paper.

When the VMN 14 attaches to the MR 12, the VMN 14 sends via the MR 12 a registration message to the HN 42. This registration message includes information such as User ID and an ID of the USER HN 40. When the MR HN 42 receives this information, it uses the ID of USER HN 40 to look up a contact address (e.g. IP address) and contacts the USER HN 40 to request the user's required QoS parameters such as: delay, bandwidth, max cost per bit or per second, jitter, etc. This information is sent to the MR HN 42 by the USER HN 40 and is saved in the MR HN together with user ID to form a user profile for the VMN 14 that is stored in memory (e.g. hard disk) by the HE 46.

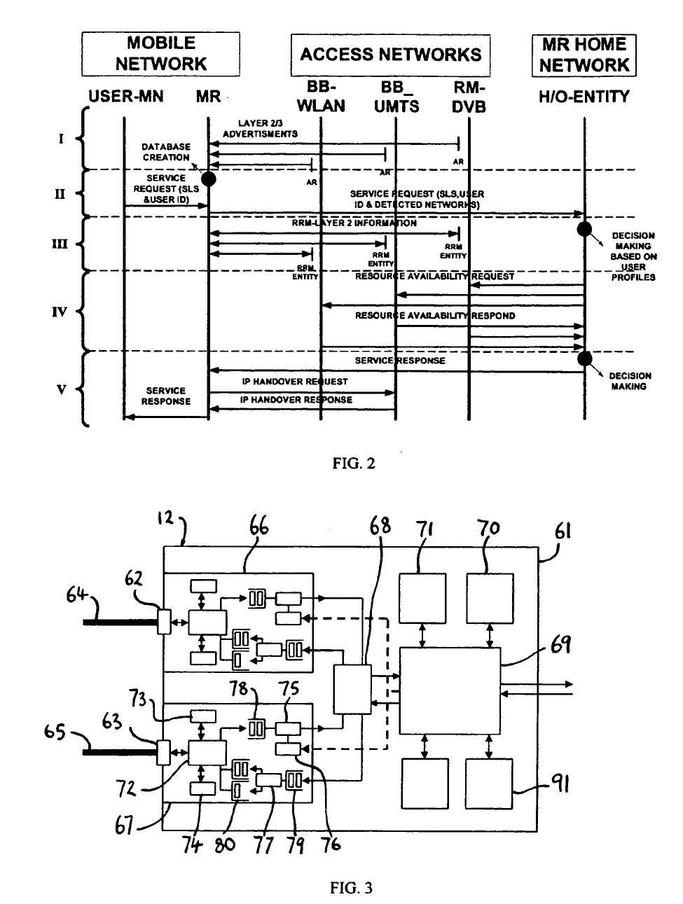

Referring to FIG. 2 a signalling diagram generally identified by reference numeral 50 shows the signalling steps in a QoS-aware access router selection method initiated by the MR 12. There are five phases to the method:

Phase I: the MR 12 gathers and stores a database of those Access Networks (ANs) to which it can connect.

Phase II: the MR 12 waits for a request for service from a network node on the train 18. Upon receipt of a request for service the MR 12 sends a MR Service Request Message to the HE 46.

Phase III: the HE 46 decides what single set of QoS parameters (group QoS level) would meet the QoS level required by each network node served by the MR 12. The HE 46 sends a Resource Availability Request (RAR) to the BB on each AN to which the MR 12 has indicated it has access. The BBs determine whether or not their networks can meet the requested QoS level and send Resource Availability Answers (RAAs) to the HE 46.

Phase IV: the HE 46 decides which AN the MR 12 should connect to for better QoS and advises the MR 12 accordingly. The MR 12 takes the necessary action to switch access point.

The method is repeated for each new request for service and also when the MR 12 is forced to perform a handover at network layer, for example when it leaves the area of signal coverage of the current access router to which it is attached.

The detailed steps of this method will be described below.

Referring to FIG. 3 the mobile router 12 comprises a case 61 having network interface ports 62 and 63 to which respective cables 64 and 65 provide a physical link to respective IP networks e.g. via AP 16. Two network interface cards 66 and 67 are connected to their respective network interface ports 62 and 63 and form the ingress interface and egress interface respectively. A hardware packet switch 68 connects the network interface cards 66, 67 and a central processing unit (CPU) 69 can communicate with a routing table 70 and router management tables 71.

Each network interface card 66, 67 comprises a link layer protocol controller 72 that has access to an interface management table 73 and a hardware address table 74 (e.g. Address Resolution Protocol cache). In communication with the link protocol controller 72 is a network protocol-forwarding engine 75 having access to a forwarding table 76 (route cache), and an interface queue manager 77. Both the network protocol forwarding engine 75 and interface queue manager 77 have an interface to and from the packet switch 68 respectively.

In use, frames are received by the link layer protocol controller 72 that handles the link layer protocol (e.g. HDLC, Ethernet, ATM) used over the physical link. Frame integrity is checked and valid frames are converted into packets by removing the link layer header and, if necessary, the packets are queued in a queue 78. Storage capacity is often in the form of a ring of memory buffers. One packet at a time is removed from the queue 78 by the network protocol-forwarding engine 75 and the forwarding table 76 determines whether or not the packet requires detailed examination by the CPU 69. Via the CPU 69 the next router or network node to which the packet should be sent is looked up in the routing table 70. If the IP packet arrived on the ingress interface (i.e. from the mobile network 10) the CPU 69 instructs encapsulation of the IP packet with an IP header addressed to the HA_MR, in order to reverse tunnel the packet over a NEMOBT as described above. If the packet has been received on the egress interface (i.e. from the access router over the wireless link) the CPU 69 instructs decapsulation of the IP packet to reveal an IP header addressed to a care-of address valid on the ingress interface as described above. Each IP header is also examined for any QoS requirements, for example a DSCP; the appropriate action is then taken by the mobile router, such as prioritising one packet flow over another. Once the destination IP address is found the CPU 69 searches the ARP cache for a Media Access Control (MAC) address for that destination. The CPU 69 now knows where to send the packet and the new link layer header to use. The link layer address is added and the packet is linked into the list of frames to be sent on from the appropriate network interface card. The packet is then forwarded to the packet switch 78 and onto the network interface card where the packet joins a queue 79 to be processed by the interface queue manager 77. From here the packet joins one of a number of link output queues 80 until the link layer protocol controller 72 can process it. The link layer protocol controller 72 encapsulates the packet in a link layer header that includes the MAC address of the next router to which the packet is to be sent. The MAC address is obtained from the hardware address table 74. The packet is then placed on the physical channel by the link layer protocol controller 72 and transmitted using the AP 16.

An electronic memory 91 (such as hard disk) stores computer executable instructions that when executed by the CPU 69 operate the QoS-aware access router selection method steps that are described in greater detail below.

Various types of mobile router are available and the present invention is not limited to that described above. Further examples are available from Cisco Systems, Inc. (www.cisco.com) for example.

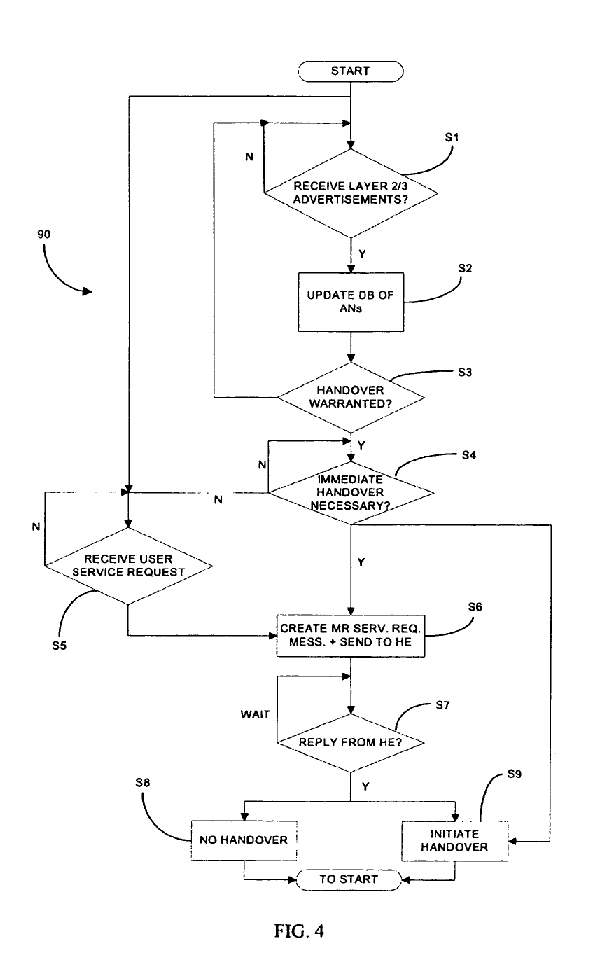

Referring to FIG. 4 the QoS-aware method steps stored in electronic memory 71 are generally identified by reference numeral 90. It is assumed that the MR 12 has been in operation for some time and a number of VMNs are being served by the MR 12, perhaps handling VoIP, web browsing, streaming multimedia, etc. on their behalf using the NEMOBT as described above. From the start, the MR 12 proceeds simultaneously to both step S1 and step S5 in which it awaits receipt of a link/MAC layer advertisement from an access router and awaits receipt of a request for service from a network node, respectively. Either of these events triggers execution of the subsequent method steps.

At step S1 the MR 12 listens for link layer and MAC layer (i.e. OSI layers 2 and 3) advertisements received at the AP 16. The advertisements inform the MR 12 of available access routers within signal range. The MR 12 stores a database of those access routers from which it has received an advertisement. The database contains a network layer address, such as an IP address, of each access router. If no advertisement is received the MR 12 waits; if an advertisement is received by the AP 16, at step S2 the MR 12 amends the database either by adding a new entry if that access router were not previously stored, or may refresh an existing entry for example by re-starting an associated lifetime. In this way the MR 12 contains a database of available access routers that is updated dynamically.

Once any amendment is made to the access router database, the MR 12 proceeds to step S3 where it determines whether or not a network layer handover might be warranted, for example: if a new entry is made in the access router database; if the current access router signal is degraded; or if a certain time has elapsed since the last QoS-aware AR selection for example. Determining whether or not QoS improvements can be made through a network layer handover might not be warranted in the case that the access router database is unchanged after step S2. In that case, the method returns to step S1.

If the MR 12 decides that further investigation of handover is warranted it proceeds to step S4 where it determines whether or not a handover is required immediately. A handover would be necessary immediately if the MR 12 is moving out of the area of signal coverage of the access router to which it is presently attached for example. In that case the MR 12 proceeds directly either to step S6 or to step S9, described below.

If no handover is necessary immediately, then the method proceeds to step S5 where the MR 12 awaits a request for a service from a network node attached to the MR. As described above the MR 12 also continuously awaits a request for service from a network node from the start. Even if no new ANs are detected by the MR 12, it may be that when a new request for service is received, QoS improvements might be made by switching to an alternative AN. The MR 12 looks for those requests that require resources of a packet-switched network. If no such request is received the MR 12 simply loops around step S5. Such a request may be triggered when the user opens a web-browsing application and therefore starts a new TCP connection via the MR 12; the MR 12 would recognise the start of a new transport layer connection by looking for TCP segments with the SYN flag set. In a QoS network environment (e.g. Diffserv), when requesting a service each network node will also request a desired QoS. As a minimum each network node should specify a performance attribute that may comprise any number of the following indicators, each of which comprises a number of performance metrics:

Indicator 1: One-way delay, measurement period, optional quantile

Indicator 2: Inter-packet delay variation, measurement period, optional quantile

Indicator 3: Packet loss rate, measurement period

Indicator 4: Throughput, measurement period

For example the one-way delay of a packet service can be important to for real-time applications such as VoIP; thus a network node might specify the following performance attribute when requesting a service:
Indicator 1: (20 ms, 5 mins, 10⁻³)

which means that the network node requires that the probability of one-way packet delay greater than 20ms is less than 10-³ measured over any 5 minute period. Each field of the performance attribute is herein referred to as a Service Level Specification (SLS) parameter.

As part of the request for service a network node may also send a full SLS template. The attributes of the SLS template may include scope, DSCP, traffic conformance, performance, service schedule and reliability for example. Definitions of these attributes can be found in “Attributes of a SLS Template”, Goderis, D. et al., October 2003 (<draft-tequila-sls-03.txt>) to which reference is-specifically made in this respect.

Furthermore the request for service message includes the user ID of the network node making the service request; the user ID is that assigned by Mobile IP and is stored in the user's profile at the HA_MN. The user ID should be a unique identifier for each network node, such as a SIP-like URL e.g. abc123@kcl.ac.uk; alternatively it may be an unique alphanumeric ID. The function of the user ID is to enable the network to associate specific requests with the AAA data of the user making the request.

When a request for a service is received (or if the MR decides immediate handover is necessary at step S4) the MR 12 proceeds to step S6, where a MR Service Request Message is composed. To compose this message the MR 12 extracts information from the access router database it has stored: the data extracted includes network layer identification (e.g. IP address) of each access router as advertised. The user ID that was received and the required QoS performance attribute are included with the access router data in the MR Service Request Message. That message is then placed as payload in one or more IP packets and transmitted to the HE 46 via the wireless link. At step S7 the MR 12 awaits a response from the HE 46. When a reply is received the MR 12 knows whether or not it should commence handover and either proceeds to step S8 where no handover is commenced, or proceeds to step S9 where handover to the selected AR is initiated. Once step S8 or step S9 is completed the method returns to the step S1 and is repeated.

If during step S7 another request for service is received from a network node another MR Service Request Message is composed and sent to the HE 46.

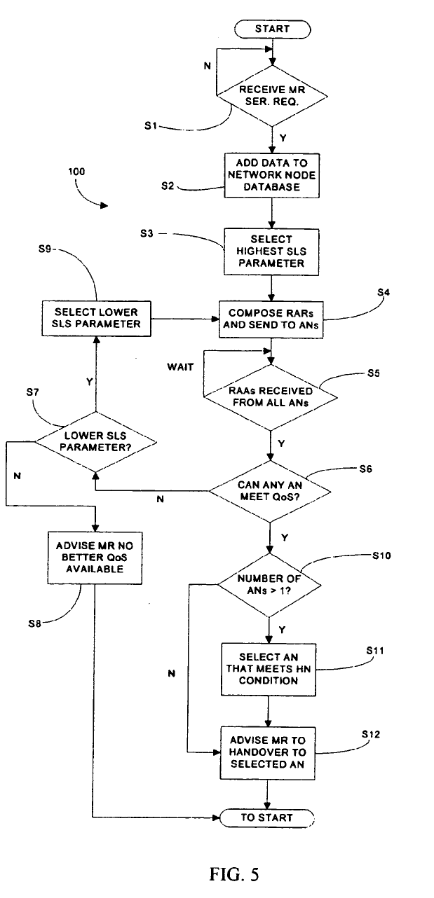

Referring to FIG. 5 the steps of the method performed by the HE 46 are generally referenced by reference numeral 100. At step S1 the HE 46 awaits receipt of a MR Service Request Message. Receipt of such a message triggers execution of the remaining steps; otherwise the HE 46 is idle. In order to reduce the amount of data sent by the MR 12 in each MR Service Request Message, for each MR 12 the HE 46 stores a network node database of those network nodes that have requested a service (and whose service is still ongoing) through the MR 12 and the SLS parameters that were requested. In this way the MR 12 only needs to send those SLS parameters of the additional service now being requested by one of the network nodes attached to the MR 12. When a network node closes a service, the MR 12 should advise the HE 46 so that it can remove the corresponding entry from this database.

When a MR Service Request Message is received, the HE 46 reads it and the data added to the network node database at step S2. The user ID contained in the MR Service Request Message enables the MR to query the database it has stored to look up the corresponding user profile that contains user QoS information as described above for example. At step S3 the HE 46 searches the performance attributes of the network node database to determine for each performance metric of each indicator that performance metric representing the highest QoS. In other words for each performance metric of each indicator the HE 46 determines the highest QoS performance metric desired and then using the results generates a group performance attribute or QoS level comprising all of the highest QoS indicators required by the network nodes stored in the network node database. The group performance attribute designates a QoS level with which all attached network nodes are satisfied or substantially satisfied. It might happen that the group performance attribute is defined by the QoS required by one network node; alternatively however, it may be defined by several different network nodes each of which demands a different particularly high single performance metric. The HE 46 is now in a position to ask BBs in the domains to which the MR 12 has access whether or not that domain can meet the group performance attribute (i.e. the most demanding QoS requirements) of the network nodes attached to the MR 12. At step S4 the HE 46 composes one or more Resource Allocation Request (RAR) message containing the group performance metric to be sent to the or each domain to which the MR 12 has indicated it has access (contained in most recent MR Service Request Message). Details of the fields contained in each RAR can be found in Neilson; the group performance metric may be carried as an optional parameter for example. The HE 46 then looks up the domains to which the MR 12 has access (contained in most recent MR Service Request Message) and addresses each RAR to the BB in each domain. The HE 46 sends the RAR messages and at step S5 awaits receipt of a Resource Allocation Answer (RAA) from each BB to which a RAR has been sent.

At step S6 the HE 46 reads each RAA that it receives. Each RAA contains a field <confirmation/reject/progress indication> thereby informing the HE 46 whether or not that domain can guarantee the required QoS expressed by the SLS parameter. Once all RAAs have been received, the HE 46 determines whether or not any of the domains can guarantee the requested group performance attribute. If none can, the method proceeds to step S7 where the HE 46 queries the network node database to find the second highest QoS level of the network nodes attached to the MR 12. If none is found, the HE 46 informs the MR 12 at step S8 that no handover should be performed. If the second highest QoS level is found however, that becomes the group performance attribute at step S9 and the HE 46 then repeats steps S4 to S6. In this way the HE 46 interrogates the BBs with a progressively lower group QoS requirements until at least one of the ANs sends a positive RAA or until there are no group performance attributes left when the HE 46 informs the MR 12 that no QoS-aware access router selection can be made. In that circumstance the MR 12 would use the ordinary best effort service of IP.

Assuming at least one positive RAA has been received at step S6, the HE 46 determines at step S1 0 if there is more than one AN that can meet the requested QoS. If so, the HE 46 should select the access router the MR 12 should use based on a MR Home Network condition such as cost, low traffic flow, etc. which can be determined by the MR network operator in advance for example, and then the HE 46 proceeds to step S12. If there is only one domain that can meet the requested QoS then the HE 46 proceeds directly from step S10 to step S12 where the HE 46 informs the MR 12 of the access router that it should use corresponding to the domain of the BB that indicated it can meet the QoS requirement. Following either step S8 or step S12 the HE 46 returns to step S1 and the selection process is repeated upon receipt of further MR Service Request Messages, either from the MR 12 or any other MR.

If during at any point a new MR Service Request Message is received by the HE 46, the performance attribute in the new request can be compared either to those performance attributes already stored in the network node database, or to the group performance attribute if it has already been determined. If all of the indicators of the new performance metric represent a the QoS that is lower than either the performance attributes stored in the network node database or the group performance attribute, the new MR Service Request Message can be ignored.

If, however, none of the stored performance attributes or group performance attribute would meet the desired QoS there are two options: (1), the network node can be added to the network node database and steps S3 onward performed i.e. a new group performance attribute determined and a handover decision is taken; or (2), the method can proceed to conclusion without taking into account the new MR Service Request Message. Which of the two options is used may depend on the point in the method at which the new request arrives. For example if the group performance attribute has already been determined then if option (1) is performed there will be extra signalling overhead and an increase in handover delay. If option (2) is performed there is no extra signalling or handover delay, but there is a risk that the group performance attribute will not meet the QoS requirements of the new network node. When the group performance attribute has already been determined and the RAR already transmitted option (2) is preferred for the reduced signalling and handover delay. If the RAR has not yet been sent it may be preferable to perform option (1). In the event that the new network node does not have its QoS requirements met the MR may re-transit the MR Service Request Message to trigger the method shown in FIG. 5 again.

As the MR 12 sends a MR Service Request Message each time there is a request for service from a network node and each time a new AN is detected, the QoS-aware selection method is dynamic. In particular, the MR 12 ensures that as each new request for service arrives from a network node it checks whether or not, of the access routers it has detected, there is a better one to attach to. Furthermore as the QoS selection is performed on the basis of a group QoS level i.e. the highest QoS requirement(s), if that condition can be met by a domain then all of the other network nodes attached to the MR 12 will have their requested QoS met.

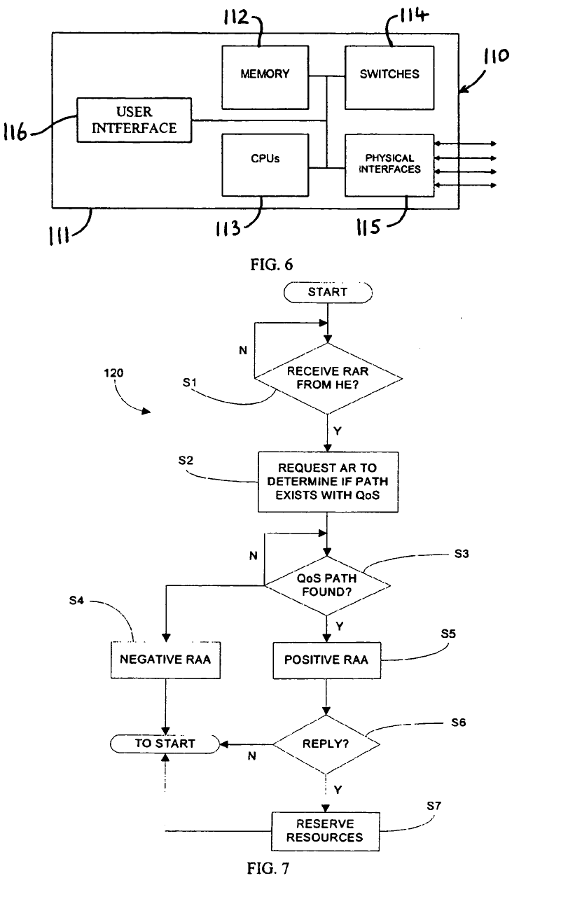

Referring to FIG. 6 each BB 34, 36, 38 may be stored in a server 110 comprising a case 111 housing an electronic memory 112 (e.g. hard disk and RAM), one or more CPU 113 one or more switch 114, and one or more physical interface 115. All of these components are in electronic communication with one another. A user interface 115 enables the network administrator to configure and control the BB 34, 36, 38. Each physical interface 115 provides access for the BB 34, 36, 38 to other network nodes (e.g. routers) within its own domain, and to BBs in other domains. The memory 112 stores computer executable instructions that when executed perform the BB method steps described below with reference to FIG. 7.

Referring to FIG. 7 BB method steps are generally identified by reference numeral 120. At step S1 the BB awaits receipt of an RAR message from the MR 12 (or any other MR). Until a RAR is received the BB is idle. Upon receipt of a RAR the BB reads the RAR to discover the group performance attribute required and the network address of access router to which the MR 12 can attach within the BB's domain. At step S2 the BB sets about determining whether or not there is a path through its domain that can meet the requested QoS. To do this, the BB communicates with the access router identified in the RAR and instructs it accordingly, as described in greater detail below. At step S3 the BB awaits a response from the access router indicating whether or not a path exists through the domain that meets the QoS requirements. If no reply is received, the BB sends a negative RAA to the HE 46 at step S4 and the BB returns to step S1. However, if a positive reply is received then the BB sends a positive RAA to the HE 46. If a positive RAA is sent to the HE 46, the BB awaits a reply from the HE 46 confirming that resources should actually be reserved. The BB does not immediately reserve the resources in the domain upon receipt of the RAR from a HE 46. Instead the BB only determines whether or not the requested resources are available, advises the HE 46 accordingly and then awaits further instructions. This ensures that resources are not needlessly reserved in several different domains simultaneously.

If a negative reply is received from the HE 46 i.e. that resources need not be reserved, then the BB returns to step S1. If a positive reply is received however, the BB instructs the access router to reserve the resources necessary to meet the requested SLS parameter at step S7. After that step the method returns to step S1.

As described above, at step S1 the BB establishes contact with the AR identified in the MR Service Request Message and at step S2 that AR decides whether or not a path meeting the requested QoS exists in the network domain. How this may be performed is described below.

Within a Diffserv domain only edge routers maintain QoS related states, whilst the core routers are stateless and simply use the DSCP to handle flows. Accordingly the BB only needs to communicate with the access router. As specified in Neilson, the BB can communicate with edge routers (e.g. an access router) within its domain using for example:
telnet: the command line interface an be used to configure the edge router(s);
Simple Network Management Protocol (SNMP): an application layer protocol that permits the exchange of management data between agents residing on a managed device (e.g. edge router) and a network management system (e.g. BB); the SNMP SET message could be used to configure edge routers;
Common Open Policy Service (COPS): a simple query and response protocol that can be used to exchange policy information between a policy server (Policy Decision Point or PDP e.g. the BB) and its clients (Policy Enforcement Points or PEPs e.g. access router).

Once the BB has established communication with the access router, the BB should take an admission control decision i.e. whether or not to admit the packet flow that will be caused by the requested service. This can be done based on the arrival time of each new request i.e. new flows are accepted sequentially until the capacity of the domain is reached. Alternatively policy-based admission control may be employed i.e. basing the admission decision not only on network resources, but also on the user ID or application and how, when and where the flow enters the network (indicated by the access router IP address for example). An example of an SLA admission control algorithm is given in “An analytical framework for SLA admission control in a DiffServ domain”, M. Mellia et al., IEEE Globecom, vol. 3, pp. 2563-2567, November 2002, to which reference is specifically made in this respect.

In order to admit a new flow, the BB has to identify a path for the flow through its domain and check the availability of the resources along this path. As explained above the domain of the BB uses QOSPF to distribute bandwidth availability data. The main idea behind the QOSPF protocol is to provide QoS routing functionalities based on the existing OSPF routing protocol, but with a minimum number of modifications. These modifications are primarily the enhancement of the link state advertisement mechanism and the routing database in order to include network resource information such as the available bandwidth. The other modification concerns the route computation algorithm to include not only the topological information but also the resource availability associated to each link. In QOSPF, the path computation algorithm selects paths which satisfy the bandwidth requirements of the flow and at the same time minimise the number of hops between two gateways in the domain. QOSPF suggests that the path selection algorithm may be triggered per request, although this is not preferred in RFC 2676 for reasons of computational expense.

QOSPF also specifies that RSVP (see RFC 2205) should be used to reserve resources along the selected path. Accordingly it is implied that QOSPF is to be applied in an Intserv-capable domain where resources are reserved per packet flow at each router in the path. However, QOSPF can be adapted for use in a DiffServ domain with a BB providing the control plane. Firstly, without any change to the QOSPF protocol, paths can be computed for aggregated flows instead of single flows. Thus, at each router paths are maintained for each DiffServ traffic class as identified by a DSCP. The routing table of each router would have a number of entries equal to the number of DiffServ classes employed. The additional modification is the replacement of RSVP per hop reservation by the centralised BB reservation described above. There are two cases: on-demand and pre-computed QOSPF.

With a pre-computed QOSPF a simple request/reply signalling protocol can be used to request admission by the BB. Based on its knowledge of available resources at each link and its interface to QOSPF, the BB performs the admission control for the incoming flow. The data packets of the corresponding aggregated flow are then forwarded at each router based on the pre-computed routing table.

With on-demand QOSPF, an explicit route is computed for the DSCP contained in the RAR of each MR Service Request Message from the HE 46. Since QOSPF is a link state routing algorithm the path may be calculated by the access router or by the BB. The core routers do not perform any routing decision, they simply forward the packets based on the DSCP contained in the IP header of the data packet, enabling lookup of the address of the next hop router. As mentioned there are two cases: the on-demand route computation is done (1) at the access router or (2) at the BB. In (1), the access router calculates a route for the DSCP of the incoming flow and transmits this information to the BB for the admission decision. Once BB has admitted the flow, it enforces the decision in the access router and at the same time the selected path is activated. In (2), the HE 46 sends a RAR to the BB as described above; the BB calculates the route for the flow, performs admission control and enforces the decision at the access router, if handover is confirmed by the HE 46. The decision includes the DiffServ data plane configuration (filter, marker, meter, policer) and the path that must be taken by the flow of packets from the MR 12. However, if the path for a particular DSCP is already set in the BB's domain, to make the admission decision the BB checks whether or not there is enough bandwidth available on the path to admit the new flow from the MR. Within the context of the present invention, however, option (2) is preferable as the BB has more flexibility of choosing the path and the egress node for that path.

Once the MR 12 has received instructions from the HE 46, it can commence network layer handover to the new access router. Network layer handover uses existing techniques well known to the skilled person as described for example in “NEMO Basic Support”, Devarapalli, et al., June 2004 (<draft-ietf-nemo-basic-support-03.txt>) to which reference is specifically made in this respect. However, for at least the duration of the handover, flows originating from the MR 12 are susceptible to packet loss and therefore degradation in QoS. In particular, when an IP handover is performed, the new access router needs DiffServ information about the marking and shaping of the flow handed over. This information can be obtained from the previous router by a QoS context transfer as described in “Context Transfer Protocol”, Loughney, J. Et al., August 2004 (<draft-ietf-seamoby-ctp-11.txt>). This latter solution avoids delay during the handover.

To protect flows undergoing network layer handover, each access router should reserve a portion of its resources specifically for those flows. In order to identify those flows that are undergoing handover and allocate those reserved resources, a mobility-aware code-point (MACP) is used in the IP header where the DSCP ordinarily resides. The new access router can identify those flows originating from the MR 12 (e.g. using the source address of IP packets forming NEMOBT between the MR 12 and the new access router) and marks them with the MACP. The MACP is transferred by direct communication (e.g. using the aforementioned Context Transfer Protocol) between the old AR and the new AR as part of pre-handover signalling. As the new access router already has resources reserved for handover flows it can perform local admission control, as part of that pre-handover signalling, without having to consult the BB.

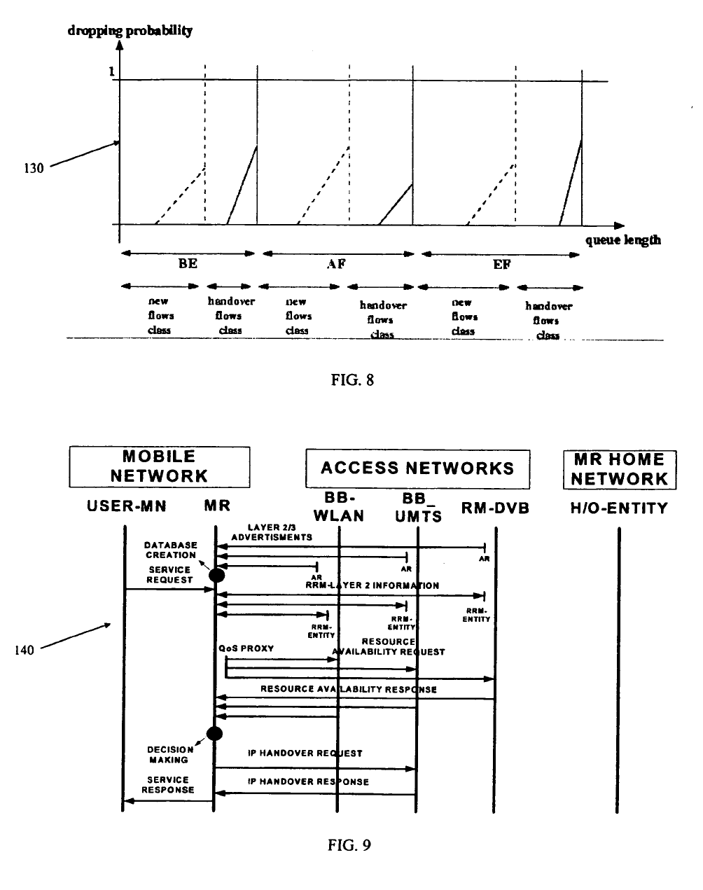

IP packets containing the MACP should be marked (e.g. by being dropped, having Explcit Congenstion Notification (ECN) bit set) with a different probabilty than IP packets without the MACP. In this way the handover flows can be protected relative to those that have not been handed over. Referring to FIG. 8 a graph generally identified by reference numeral 130 shows dropping probability versus queue length. It will be noted that packets with a MACP do not start being marked until some queue length beyond the point at which all packets in new flows are marked i.e. with a probability of one. Furthermore each MACP is treated differently depending on whether the flow to be treated with Best Effort (BE), Assured Forwarding (AF) or Expedited Forwarding (EF).

By using a different marking probability for packets with the MACP, there is no need to re-initiate the resource reservation with the BB before the handover execution. However after a certain period of time the resources occupied by the handover flows should be released so that future handover flows may use them. Furthermore a threshold mechanism can be used in order to reserve and release resources proactively. This mechanism reduces handover delay caused by the QoS negotiation between the BB and the AR during the pre-handover phase.

One advantage of this scheme is a decrease in the amount of signalling between the BB and the AR during the pre-handover phase and therefore decrease the handover delay. An additional advantage is a decrease in the QOSPF link state advertisements caused by the handover flows, because the resources are pre-reserved at the access router in a batch manner.

Referring to FIG. 9 a second embodiment of the QoS-aware access router selection method is generally identified by reference numeral 140. The method 140 is generally similar to the method described with reference to FIGS. 1 to 8. In this embodiment however, the each network node stores his own user profile, rather than being stored by the MR's Home Agent and on the HE 46. This means that the MR 12 can interrogate each network node to ascertain user priority information for example i.e. whether or not some users are to be given preference over otherse. Accordingly the HE 46 is part of the MR 12 and performs the same functions decribed above. In this embodiment all of the steps of the access router selection method (other than those of the BBs) take place on the MR 12.

It will be appreciated that the invention is applicable in any environment in which a group of mobile network nodes move together and are considered as one at the network layer, and is not limited to use in a NEMO; furthermore it is applicable in any QoS environment and is not limited to use in Diffserv domains.

Mobile routers may be installed in a wide range of vehicles including private vehicles (e.g. cars, motorbikes), public transport (e.g. buses, trains, trams, taxis, planes, ferries) and military vehicles (aircraft, tanks, lorries, boats, etc.)

Although the embodiment of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program. For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant methods.

1. In a heterogeneous network environment a method of selecting an access router among a number of available access routers for a group of mobile network nodes attached to a mobile router, each access router providing access to packet-switched resources in a respective network domain and each mobile network node having a desired QoS level at the network layer, which method comprises the steps of:
(a) determining a group QoS level acceptable to substantially all mobile network nodes in said group;
(b) using said group QoS level to query at least one of said number of respective network domains to determine whether or not it can meet said group QoS level; and
(c) using a response from said at least one network domain to decide whether or not to perform a network layer handover of said group of mobile network nodes to one of said number of available access routers.

2. A method according to claim 1, wherein steps (a) to (c) are performed in response to a request for service sent by one of said mobile network nodes.

3. A method according to claim 1, wherein steps (a) to (c) are performed in response to the need for a network layer handover indicated by a degradation of wireless signal quality.

4. A method according to claim 1, wherein step (b) comprises the step of composing a Service Request Message having fields for carrying data representing said group QoS level and an identity of each of said number of available access routers.

5. A method according to claim 4, wherein said Service Request Message comprises a field for carrying data representing an identity of a mobile network node.

6. A method according to claim 1, wherein step (a) comprises the step of evaluating said group QoS level by selecting a highest QoS from among the QoS level desired by each mobile network node.

7. A method according claim 6, wherein said QoS level is defined by a performance attribute of packet routing at the network layer.

8. A method according to claim 1, wherein step (b) comprises the steps of composing at least one Resource Allocation Request (RAR) message having a field for said group QoS level, transmitting said at least one RAR message to a respective network domain and awaiting a response therefrom.

9. A method according to claim 8, wherein if the or each respective network domain indicates that it cannot meet the requested group QoS level, said group QoS is re-evaluated by selecting a lower QoS level from among the QoS level desired by each mobile network node, and a further RAR is composed and transmitted to said respective network domain.

10. A method according to claim 1, wherein step (c) comprises the step of awaiting at least one Resoure Allocation Answer (RAA) message from said respective network domain and, if a positive RAA message is received indicating that network domain can meet said group QoS level, handing said group of mobile network nodes over to the available access router in that network domain.

11. A method according to claim 10, wherein if more than one positive RAA message is received, the method further comprises the step of selecting an available access router according to a home network condition of said mobile router.

12. A method according to claim 1, wherein in response to a query sent in step (b) said at least one respective network domain determines whether or not a path exists thereacross that meets said group QoS level.

13. A method according to claim 12, wherein said at least one network domain uses a QoS link state routing alorithm whereby each router of the domain has knowledge of the QoS capability of every other link within said domain, whereby said path being determined by examination of a routing table within one router in the domain.

14. A method according to claim 1, further comprising the step of confirming selection of one of said respective network domains, and in response to said confirmation said selected network domain reserves resources to meet said group QoS level.

15. A method according to claim 14, further comprising the steps of applying a Mobility Aware Code Point (MACP) to packet data entering said selected network domain that originates from said group of mobile network nodes, which MACP causes said packet data to be prioritised relative to other packet data at routers within said selected network domain.

16. A method according to claim 15, further comprising the step of applying within said selected network domain a lower marking probability to packet data flows comprising said MACP, whereby those packet data flows from said mobile network nodes are protected relative to other packet data flows in said selected network domain.

17. A method according to claim 15, further comprising the step of applying said MACP for at least the duration of said network layer handover.

18. A method according to claim 1, wherein said query in step (b) is transmitted to a handover entity intermediate said group of mobile network nodes and said respective network domains.

19. A method according to claim 18, wherein said handover entity performs steps (a) and (b).

20. A method according to claim 1, wherein said group QoS level is acceptable to all of said group of mobile network nodes.

21. A method according to claim 1, wherein said mobile router and said group of mobile network nodes comprise a mobile network.

22. A method according to claim 21, wherein said mobile network operates using NEMO, NEMO-like or NEMO-derived protocol.

23. In a heterogeneous network environment a method of selecting an access router among a number of available access routers for a group of mobile network nodes attached to a mobile router, each access router providing access to packet-switched resources in a respective network domain and each mobile network node having a desired QoS level at the network layer, which method comprises the steps of:
(a) mobile routers moving in the heteroegeneous network environment performing the follwing steps in response to a request for service sent by one of said mobile network nodes:
(i) determining a group QoS level acceptable to substantially all mobile network nodes in said group;
(ii) using said group QoS level to query at least one of said number of respective network domains to determine whether or not it can meet said group QoS level; and
(iii) using a response from said at least one network domain to decide whether or not to perform a network layer handover of said group of mobile network nodes to one of said number of available access routers;
(b) a handover entity evaluates said group QoS level by selecting a highest QoS from among the QoS level desired by each mobile network node; and
(c) in response to a query sent in step (ii) a bandwidth broker in each of said respective network domains to which said mobile routers have access determines whether or not a path exists thereacross that meets said group QoS level.

24. A method according to claim 23, wherein said handover entity operates on a network node remote from said mobile router, providing a single network node to which queries from said mobile routers can be directed.

25. A method according to claim 23, wherein said handover entity operates on each mobile router.

26. A computer program for use in heterogeneous network environment in a method of selecting an access router among a number of available access routers for a group of mobile network nodes attached to a mobile router, each access router providing access to packet-switched resources in a respective network domain and each mobile network node having a desired QoS level at the network layer,
said computer program comprising computer executable instructions for causing one or more network node to perform the method steps of:
(a) determining a group QoS level acceptable to substantially all mobile network nodes in said group;
(b) using said group QoS level to query at least one of said number of respective network domains to determine whether or not it can meet said group QoS level; and
(c) using a response from said at least one network domain to decide whether or not to perform a network layer handover of said group of mobile network nodes to one of said number of available access routers.
